(19) United States
(12) Patent Application Publication
(10) Pub. No.: US 2025/0112365 A1
(43) Pub. Date: Apr. 3, 2025

(54) OMNI-DIRECTIONAL, MINIATURIZED ANTENNA SYSTEM

(71) Applicant: Intel Corporation, Santa Clara, CA (US)

(72) Inventors: Walid EL HAJJ, Antibes (FR); Serge DAO, Vallauris (FR); Jayprakash THAKUR, Bangalore (IN); Nawfal ASRIH, Mandelieu-la-Napoule (FR); Wilfrid LEFEVRE, Valbonne (FR); Yoni KAHANA, Kfar Hess (IL)

(21) Appl. No.: 18/477,568

(22) Filed: Sep. 29, 2023

(51) Int. Cl. H01Q 5/385; H01Q 1/38; H01Q 1/50; H01Q 21/28

(52) U.S. Cl. CPC H01Q 5/385; H01Q 1/38; H01Q 1/50; H01Q 21/28

(57) ABSTRACT

Disclosed herein are devices, systems, and methods for an antenna system that may be used not only for wireless communications but also for other antenna-based applications such as proximity sensing, ranging, and angle of arrival measurements. The antenna system includes a plurality of antenna groups that include a first antenna group and a second antenna group. The first antenna group includes a parasitic element and a radiating element fed by a antenna port. The second antenna group includes a second parasitic element and a second radiating element fed by a second antenna port. The antenna system also includes a ground plane coupled to the first antenna group and the second antenna group. The first antenna group may be separated from and mirrored by the second antenna group.

### TECHNICAL FIELD

This disclosure relates generally to antenna systems, and in particular to omni-directional, miniaturized antenna systems that may be suitable for radio frequency transmissions as well as sensing applications, ranging applications, and/or localization applications.

### BACKGROUND

As wireless devices such as smart phones, tablets, wearables, notebooks, personal computers, etc. become more popular, the antenna systems may be used for purposes other than wireless communications. For example, many applications exploit the wireless capabilities on a device in order to provide additional features such as proximity detection, motion detection, gesture sensing, localization, and health monitoring. Generally, such applications may repurpose the wireless system, and in particular, the wireless antenna system, in order to provide these additional features. However, these additional features often involve more challenging antenna characteristics.

One of the main challenges, especially in the context of a notebook or laptop formfactor, is to have an omnidirectional antenna system made from two or more antennas, at least one for transmit (TX) and at least one for receive (RX) (sometimes both used as RX), where their global size is small enough to fit into the lid bezel or other small space, depending on the form factor of the wireless device, where the global size includes the distance between the two or more antennas. In addition, antennas may be fed by a coaxial connecting cable, which may introduce performance degradations. Furthermore, it may be difficult to provide isolation between the two or more antennas.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary aspects of the disclosure are described with reference to the following drawings, in which:

FIG. 1 shows an example of an antenna system that consists of two, separated radiating groups that mirror one another;

FIG. 2 illustrates an example of an antenna system that consists of three, separated radiating groups that mirror one another;

FIG. 3 illustrates an example plot of the reflection coefficient of the antenna system of FIG. 1;

FIG. 4 shows an example plot of the transmission coefficient of the antenna system of FIG. 1;

FIG. 5 depicts an example plot of the radiation patterns of each antenna group of the antenna system of FIG. 1;

FIG. 6 illustrates an example plot of phase difference of arrival (PDoA) as a function of angle of arrival (AoA) for simulations and measurements of a prototype of the antenna system of FIG. 1; and

FIG. 7 shows an example plot of the measured distance versus physical AoA in azimuth.

### DESCRIPTION

The following detailed description refers to the accompanying drawings that show, by way of illustration, exemplary details and features.

The word “exemplary” is used herein to mean “serving as an example, instance, or illustration.” Any aspect or design described herein as “exemplary” is not necessarily to be construed as preferred or advantageous over other aspects or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in the form of a pointer. The term “data”, however, is not limited to the aforementioned examples and may take various forms and represent any information as understood in the art.

The terms “processor” or “controller” as, for example, used herein may be understood as any kind of technological entity (e.g., hardware, software, and/or a combination of both) that allows handling of data. The processor or controller may be or be part of a system-on-chip (SoC) and may consume power when handling data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, software, firmware, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint™, among others, or any combination thereof. Registers, shift registers, processor registers, data buffers, among others, are also embraced herein by the term memory. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as radio frequency (RF) transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both “direct” calculations via a mathematical expression/formula/relationship and ‘indirect’ calculations via lookup or hash tables and other array indexing or searching operations.

As noted above, antenna systems may be used for purposes other than just wireless communications, including, for example, proximity detection, motion detection, gesture sensing, localization, and health monitoring. Generally, such application may repurpose the antenna system in order to provide these additional features, but these additional features, however, often introduce more challenging antenna characteristics, especially in the context of small formfactors, such as a notebook or laptop, where the entire antenna system must fit within a small area, such as within the lid bezel of the laptop. In many cases, the antenna system may include two or more antennas (e.g., at least one for TX and at least one for RX) to provide omni-directional wireless communications, may use a coaxial connecting cable to feed the antennas, and may require sufficient isolation between the RX and TX antennas. Until now, it has not been possible to satisfy all of these requirements within a single antenna system, while also reliably providing additional feature support from the same antenna system for additional antenna-related features such as proximity sensing, ranging, and angle of arrival measurements.

For example, patch directional antennas are known that may be commonly used for Ultra-Wide Band (UWB) detection and ranging applications in handheld devices, but these may not be omni-directional, may have a limited coverage angle which may limit the field of view between the device and the user, and often have a cumbersome (e.g., large) dimension compared to the wavelength. For instance, a typical patch directional antenna for UWB detection may have as a size of approximately 18 mm by 18 mm which means that it would be difficult to integrate in a laptop screen. In addition, a patch directional antenna cannot be easily connected to coaxial cables which makes it less suitable for laptop formfactors, where the chipset is localized and relatively far from the antennas, and therefore may need to be fed with a coaxial cable. Omnidirectional antennas are known for UWB detection applications, but these generally suffer from poor phase monotony, which means that it is not suitable for use in localization measurements, like angle of arrival, where phase monotony may be important for reliable measurements. Planar Inverted-F Antennas (PIFA) have been used in omnidirectional Wi-Fi and Wi-Fi sensing applications, but these may also suffer from non-monotonic phase behavior, especially if connected via an external coaxial cable.

Disclosed herein is a new antenna system solution, where phase balance is intrinsically integrated into the design. The disclosed antenna system may allow for better performance of localization/sensing features with limited antenna size and may allow for a connection to a coax cable while maintaining good omnidirectionality and good efficiency. The disclosed antenna system may also be small in size. For example, the disclosed antenna system may be made from at least two antennas designed to be in a space that is less than about 1.6 mm×30 mm, separated by about a half wavelength distance (e.g., about 18 mm for a 7.5 GHz to 8.5 GHz operating frequency range with about an 8 GHz center frequency) which makes it suitable to be embedded into notebooks, tablets, smartphones, wearables, medical devices, and other wireless devices with small formfactors. The disclosed antenna system may allow for the use of up to a 50 cm coaxial cable while maintaining good antenna gain, efficiency, and phase monotony. The disclosed antenna system may allow for a quasi-omnidirectional coverage with limited variation of the gain spherical pattern. The disclosed antenna system may allow for a monotonic phase behavior with and without the use of coaxial cable, which makes it suitable for the measurement of additional localization feature like angle of arrival (“AoA”) measurements. The disclosed antenna system may not add additional cost because the antenna may be part of the initial design of the wireless device, and no additional, specific hardware is needed as compared to a conventional antenna. Overall, the disclosed antenna system may improve the wireless device's performance and user experience, provide omni-directional coverage, be small, and be used with coaxial cables, all while reliably providing additional features of proximity detection, ranging, and AoA measurements.

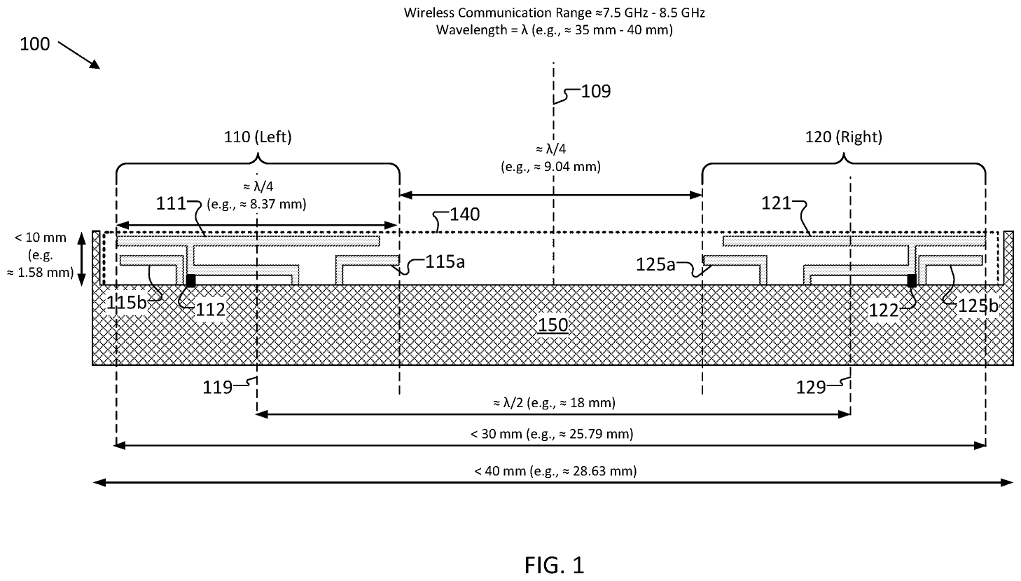

FIG. 1 shows an example of an antenna system 100 that consists of two, separated radiating groups, where one group is labeled as left group 110 and the other group is labeled as right group 120, where each group may act as a separate antenna. The radiating groups (110, 120) of the antenna system 100 may be printed on a printed circuit board (PCB) substrate (e.g., flame-retardant four (FR4)) with a permittivity 4.4 and thickness 0.2 mm, and connected to a ground plane 150, which may be connected to or be the chassis of the device. As should be appreciated, the other types of PCB substrate may be used with different partitivities and thicknesses. Each of the antenna groups (110, 120) may be fed by a respective antenna port. For example, left antenna group 110 is fed by antenna port 112 and right antenna group 120 is fed by antenna port 122. As a practical matter, the antenna ports (112, 122) typically send/receive the radio frequency signals (RF) from/to the transceiver via a corresponding coaxial cable (not shown) connected to each antenna port. The coaxial cable may be soldered to the ground plane 150, and may be fed, for example, through the ground plane 150 to reach the respective antenna port. Any type of radio-frequency (RF) connectors may be used for the connection at the antenna ports (112, 122).

The dimensions presented in the example of FIG. 1 are for a design optimized in the UWB frequency range to cover an operational frequency band from about 7.5 GHz to 8.5 GHz, where the center frequency is about 8.0 GHz. The geometric extent of each antenna group (110, 120) is 8.37 mm by 1.58 mm and includes a radiating element (left radiating element 111, and right radiating element 121) connected to the respective feed port (112, 122) and may include parasitic elements. As used herein, the geometric extent of the antenna group refers to a dimension that covers the extent of all the elements of antenna group (e.g., all the radiating elements, parasitic elements, etc.) in that dimension (thus, the geometric width of the left antenna group 110 is 8.37 mm along the width dimension and the geometric height is 1.58 mm along the height dimension). The radiating elements and parasitic elements may be any shape, including meandered-shaped elements (e.g., an L-shape, an F shape, an E shape, a snake shape, etc.), where the length may not extent in a single direction but may fold back on itself at varying angles.

For example, the left antenna group 110 has two L-shaped parasitic elements (right parasitic element 115a and left parasitic element 115b) connected to ground plane 150. Similarly, right antenna group 120 has two L-shaped parasitic elements, right parasitic element 125a and left parasitic element 125b). In this case, the geometric extent of each antenna group is 8.37 mm in the dimension along the ground plane (in FIG. 1, horizontal) and 1.58 mm in the dimension perpendicular to the ground plane (in FIG. 1, vertical) (including both antenna groups, more generally, less than about 30 mm along the ground plane and less than about 5 mm perpendicular to the ground plane). The two antenna groups (110, 120) are separated on center by a distance of about 18 mm (e.g., about half the wave length of the center frequency of the operational band) and the distance between nearest extents of the antenna groups is about 9.04 mm (thus, the geometric extent of both antenna groups is about 25.79 mm). The total keep-out zone 140 of the antenna system 100 (which includes the geometric extent of both antenna groups) may be less than about 40 mm by about 10 mm (e.g., about 28.63 mm by about 1.58 mm for an antenna that operates at about 8 GHZ), making it suitable for integration into small form factors, such as the lid of a laptop.

As should be understood, the dimensions may be adjusted proportional to the center frequency of the operational frequency band. The distance on center between the two antenna groups, for example, may be about a half-wavelength of the center frequency of the operating band, and the geometric extent of each antenna group may be about a quarter-wavelength. Thus, the antenna may be easily tuned to cover other frequency bands or technologies like Wi-Fi while keeping the same concept and advantages. As should be appreciated, while FIG. 1 shows two parasitic elements (e.g., mirrored L-shaped elements) within each antenna group, each antenna group may have any number of parasitic elements, preferably mirrored as within each group and/or mirrored as between both groups.

Antenna system 100 may be used in different modes to provide for different sensing and localization features. To operate in a sensing mode to provide sensing features (e.g., radar human detection), the left antenna group 110 may be used for TX and the right antenna group 120 may be used for RX (or vice-versa). To operate in a ranging mode to provide ranging features (e.g., distance measurements), left antenna group 110 may be used for TX and RX, while right antenna group 120 may also or alternatively be used for TX and RX (e.g., one antenna group or both antenna groups may be used). To operate in an angle measurement mode to provide AoA features (e.g., angle measurements), left antenna group 110 may be used for RX and right antenna group 120 may be used in TX. As should be understood, the AoA measurement is one of the main challenges in this kind of antenna system. For good performance, the phase difference between the two antennas (also called phase difference of arrival (PDoA)) should be monotonic when the antennas are receiving electromagnetic (EM) waves from different angles of arrivals (AoA). Non-monotony may induce an ambiguity in the AoA measurement and reduce the performance/reliability of this feature.

The design of antenna system 100 may provide monotonicity and a good phase balance due to the mirroring of the two antennas. In other words, the stability of phase difference between the two antennas (e.g., the two antenna groups 110, 120) may be ensured by the mirroring of the radiating and parasitic elements, which may induce a kind of EM balance that removes the surfaces waves and the unnecessary coupling. Furthermore, the additional L-shape parasitic elements may help to improve this balance.

As shown in FIG. 1, the left antenna group 110 is mirrored with respect to the right antenna group 120 across axis of reflection 109. This can be seen, for example, in the shape of left radiating element 111 (of left antenna group 110), which mirrors the shape and position of right radiating element 121 (of right antenna group 120) across axis of reflection 109. Similarly, the parasitic elements (L-shaped parasitic elements 115a/115b) of left antenna group 110 mirrors the shape and orientation of the L-shaped parasitic elements 125a/125b of the right antenna group 120 across the axis of reflection 109.

In FIG. 1, not only are the antenna groups mirrored as to one another (across the axis of reflection 109), the parasitic elements of each group are mirrored as well, internally, with respect to its antenna group (e.g., across an axis of reflection at the geometric center of the antenna group). Thus, using the left antenna group 110 as an example, the L-shaped parasitic element 115a mirrors the shape and position of the L-shaped parasitic element 115b the axis of reflection 119 at the geometric center of the left antenna group 110. For example, the L-shaped parasitic element 115a has a long portion that runs along the direction of the ground plane (e.g., horizontal in FIG. 1) connected at its end to a short portion that runs perpendicular to the ground plane (e.g., vertical in FIG. 1). The short portion is connected to ground plane 150 and there is a space between the long portion and the ground plane that opens toward the right antenna group 120. The L-shaped parasitic element 115b is the mirrored version across the axis of reflection 119, where the short portion is connected to ground plane 150 and there is a space between the long portion and the ground plane that opens away from the right antenna group 120. The right antenna group 120 has similar internal mirroring across the axis of reflection 129 at the geometric center of the right antenna group 120.

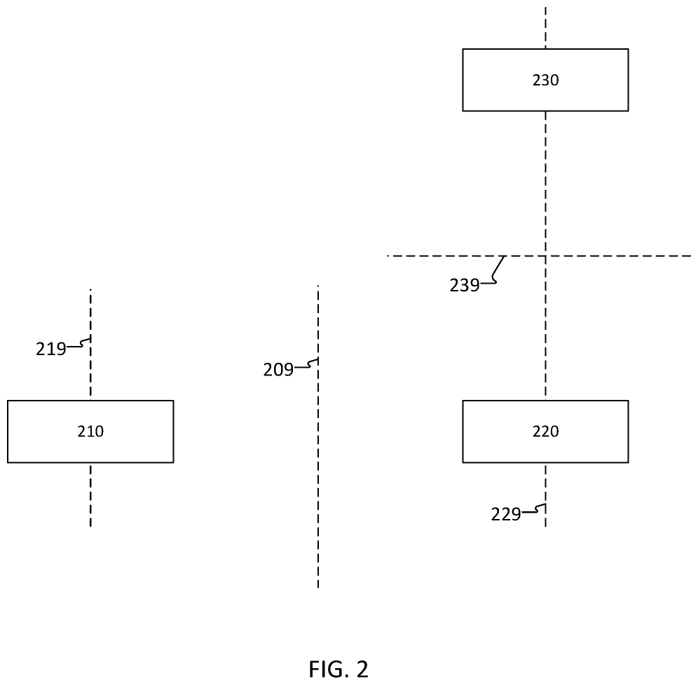

As should be appreciated, while two antenna groups are discussed herein, additional antenna groups may be included. For example, a third antenna group may be added that lies in a plane above one of the other antenna groups. Using right antenna group 120 as an example, a third antenna group may be above right antenna group 120 (toward the top of the page), also centered on axis 129. As with the right antenna group 120 and/or left antenna group 110 discussed above, the parasitic elements of the third antenna group may be mirrored as well, internally, with respect to itself (e.g., across an axis of reflection at the geometric center of the antenna group). The third antenna group may also be mirrored with respect to the right antenna group 120 across an axis of reflection that is perpendicular to axis 129. This arrangement is shown in FIG. 2, where first antenna group 210 is mirrored across axis of reflection 209 with respect to second antenna group 220. A third antenna group 230 is mirrored with respect to second antenna group 220 across axis of reflection 239.

In addition, the parasitic elements of each antenna group may be optionally mirrored internally with respect to itself. Thus, the parasitic elements of the first antenna group 210 may be internally mirrored with respect to itself across axis of reflection 219, the parasitic elements of the second antenna group 220 may be internally mirrored with respect to itself across axis of reflection 229, and the parasitic elements of the third antenna group 230 may be internally mirrored with respect to itself across axis of reflection 229. In terms of AoA measurements, the third antenna group 230 with respect to second antenna group 220 may measure AoA in elevation while the first antenna group 210 with respect to the second antenna group 220 may measure AoA in azimuth, allowing for a three dimensional resolution of AoA measurements. This concept may be expanded to additional antennas with similar mirroring, internally with respect to the antenna group, and with respect to the other antenna groups.

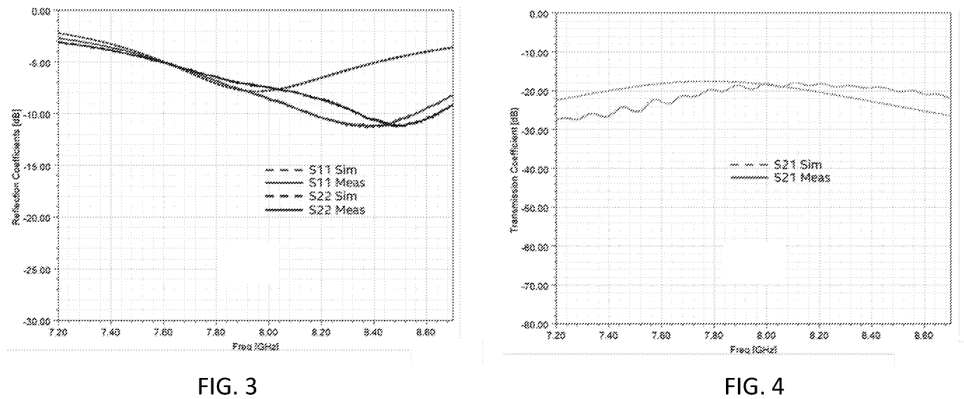

FIGS. 3-5 show test results of a simulation and of a prototype antenna system according to the example of antenna system 100 of FIG. 1. FIG. 3 plots the reflection coefficient (in dB) and FIG. 4 shows the transmission coefficient (in dB) of antenna system 100 over frequency (in GHz). As may be seen in FIGS. 3 and 4, antenna system 100 covers the designed frequency band centered at 8 GHz with a very good isolation between the two antennas (e.g., above 18 dB). Good correlation between simulations (labeled as “Sim”) and measurement (labeled as “Meas”) is also observed.

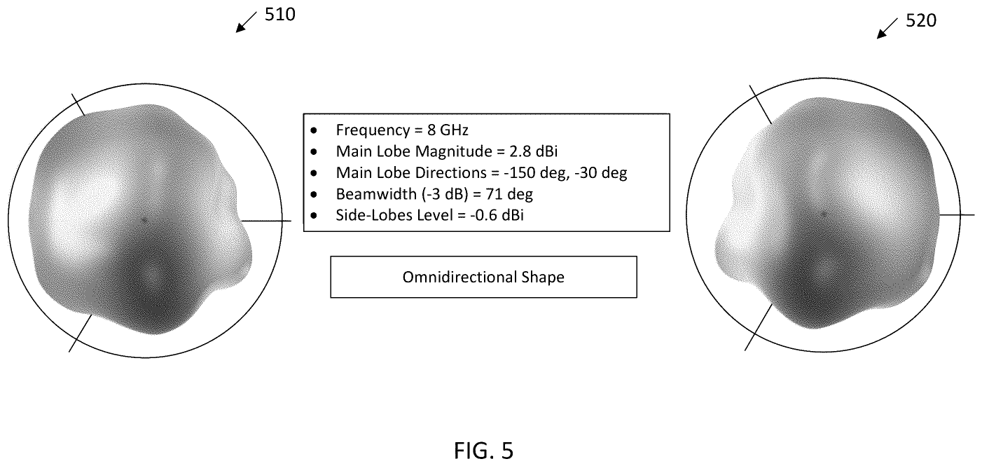

FIG. 5 separately plots the radiation patterns of each antenna group in the antenna system, where radiation pattern 510 is for left antenna (e.g. antenna group 110) and radiation pattern 520 is for the right antenna (e.g., antenna group 120). As can be seen, the radiation characteristics show that each antenna group has a quasi-omnidirectional shape of the radiation (e.g., large 3 dB beamwidth (71 deg)) with relatively high side-lobe level (0.6 dB).

As noted above, one of the benefits of the disclosed antenna system (e.g., antenna system 100) is that it may provide a monotonic phase difference between the two antennas. In other words, the PDoA vs. AoA variation make the antenna system suitable for AoA measurements. The general concept of an AoA measurement is that two antennas (e.g., the two antenna groups 110, 120 of antenna system 100) operate in RX mode to receive signals with a specific phase difference (PDoA). Knowing the distance (D) between the two antennas and the measured value of the PDoA, the AoA may be determined based on the relationship

$$Δφ = PDoA = \frac{360 °}{λ} \cdot D \cdot sin ( AoA ) ,$$

where λ is the wavelength of the incident wave.

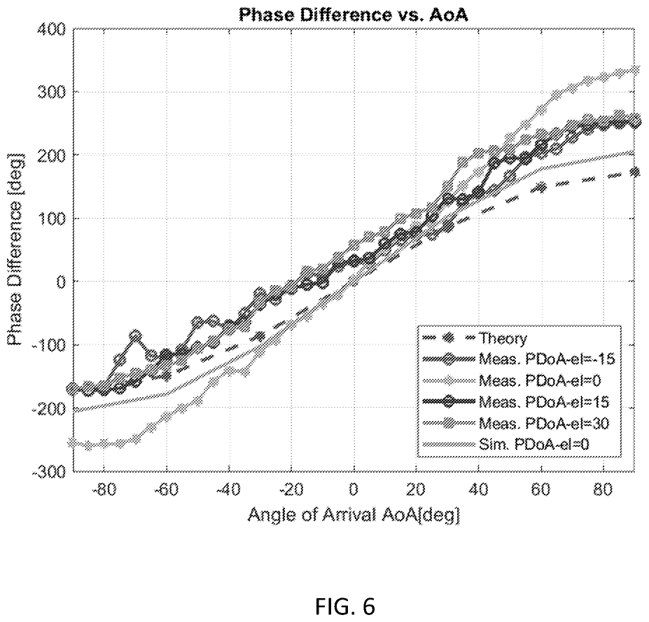

FIG. 6 plots PDoA over AoA for simulations and measurements of a prototype of antenna system 100 and compared to a theoretical value (e.g., the relationship above, plotted as “Theory”). The measurements in the plot were performed using a vectoral network analyzer and a transmitting antenna that was moved to change the AoA with respect to the receive antenna (e.g., the prototype of antenna system 100), using different elevations of the receive antenna (e.g., lines on the plot showing elevation (“el”) angles of −15, 0, 15, and 30 degrees with respect to vertical) to simulate, for example, different lid positions if the antenna system were installed on in the lid of a laptop device. As can be seen, the measurements and simulations show a very good monotonic behavior for PDoA vs. AoA, which makes such an antenna system suitable to be used for AoA measurements. The different variations at different elevations may be accounted for as part of a calibration of the antenna system.

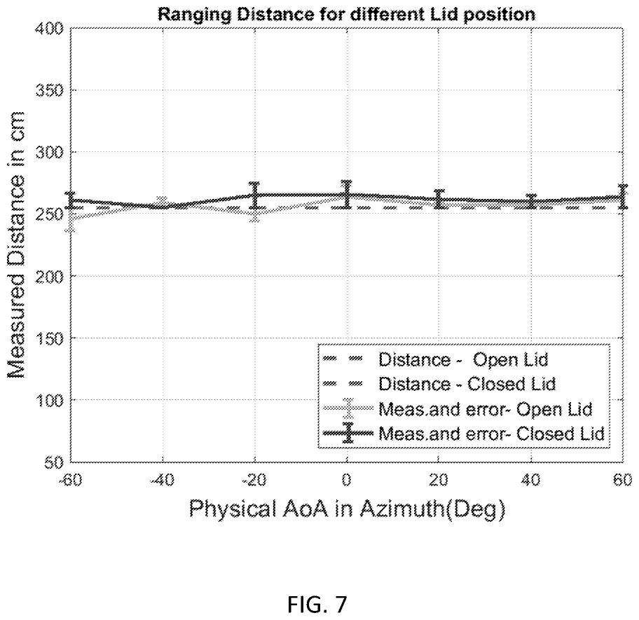

With respect to using the antenna system in a ranging mode for sensing and localization applications, a prototype was attached to a large metallic plate (to act as a ground plane of the chassis/lid. The prototype was connected to an ultra-wide band (UWB) demo chipset using 50 cm coaxial cables. On the other side, a UWB demo board with embedded antennas was used as counterpart. FIG. 7 plots the measured distance (in cm) against physical AoA in azimuth (degrees). As can be seen, there is a small ranging error for a large field of view (FoV) and at different lid positions (open lid and closed lid). Thus, the antenna system may be reliably used (e.g., omnidirectionality, robustness, accuracy) in a ranging mode for or sensing and localization applications.

In the following, various examples are provided that may include one or more aspects described with respect to the antenna system described above. The examples provided in relation to the devices may apply also to the described method(s), and vice versa.

Example 1 is an antenna system including a plurality of antenna groups that includes a first antenna group and a second antenna group, wherein the first antenna group includes a first parasitic element and a first radiating element fed by a first antenna port, wherein the second antenna group includes a second parasitic element and a second radiating element fed by a second antenna port. The antenna system also includes a ground plane coupled to the first antenna group and the second antenna group, wherein the first antenna group is separated by a distance along the ground plane from the second antenna group, wherein the first antenna group mirrors the second antenna group.

Example 2 is the antenna system of example 1, wherein the first antenna group mirrors the second antenna group with respect to an axis of reflection at a center of the distance, wherein the axis of reflection is perpendicular to the ground plane.

Example 3 is the antenna system of either one of examples 1 or 2, wherein each of the first parasitic element and the second parasitic element is a meandered-shaped parasitic element.

Example 4 is the antenna system of example 3, wherein the meandered-shaped element is L-shaped.

Example 5 is the antenna system of either one of examples 3 or 4, wherein the meandered-shaped parasitic element includes a first portion that extends along the ground plane and is separated therefrom and a second portion that extends in a direction perpendicular to the ground plane and connects thereto, wherein an end of the first portion is connected to an end of the second portion.

Example 6 is the antenna system of example 5, wherein the first portion is longer than the second portion.

Example 7 is the antenna system of example 6, wherein the first parasitic element mirrors the second parasitic element with respect to an axis of reflection at a center of the distance, wherein the first portion extends along the ground plane away from the end of the second portion and towards the center.

Example 8 is the antenna system of any one of examples 1 to 7, wherein the first antenna group includes a first additional parasitic element and the second antenna group includes a second additional parasitic element, wherein each of the first additional parasitic element and the second additional parasitic element is meandered-shaped.

Example 9 is the antenna system of example 8, wherein the first parasitic element mirrors the first additional parasitic element across an axis of reflection of the first antenna group that is located at a geometric center of the first antenna group and is perpendicular to the ground plane.

Example 10 is the antenna system of any one of examples 1 to 9, wherein each of a geometric extent of the first antenna group along the ground plane and a second geometric extent of the second antenna along the ground plane includes about half the distance.

Example 11 is the antenna system of any one of examples 1 to 10, wherein each of the first antenna group and the second antenna group, when in operation, have an omnidirectional-like radiation pattern.

Example 12 is the antenna system of any one of examples 1 to 11, wherein the first antenna group and second antenna group are arranged on a printed circuit board substrate.

Example 13 is the antenna system of example 12, wherein the printed circuit board substrate includes a flame retardant material (e.g., FR4), wherein the flame retardant material has a permittivity of about 4.4 and a thickness of about 0.2 mm.

Example 14 is the antenna system of any one of examples 1 to 13, the antenna system further including a radio frequency (RF) cable configured to connect the antenna system to a wireless module, wherein the RF cable is connected to the first antenna port to feed the first radiating element.

Example 15 is the antenna system of example 14, the antenna system further including a second radio frequency (RF) cable configured to connect the antenna system to the wireless module, wherein the RF cable is connected to the second antenna port to feed the second radiating element.

Example 16 is the antenna system of example 14, wherein the first antenna group, second antenna group, and wireless module are housed within a chassis.

Example 17 is the antenna system of any one of examples 1 to 16, wherein the first antenna group and the second antenna group are configured for wireless communications in a frequency range of about 7.5 GHz to 8.5 GHz.

Example 18 is the antenna system of any one of examples 1 to 17, wherein the distance is about a half-wavelength (λ) at a central frequency of a wireless communication frequency range of the antenna system.

Example 19 is the antenna system of example 18, wherein the half-wavelength is about 18 mm when the central frequency is about 8 GHz and the wireless communication frequency range is about 7.5 GHz to 8.5 GHz.

Example 20 is the antenna system of any one of examples 1 to 19, wherein a geometric width along the ground plane of the first antenna group is between about a quarter-wavelength and about a fifth-wavelength at a central frequency of a wireless communication frequency range of the antenna system.

Example 21 is the antenna system of example 20, wherein the geometric width is about 8.37 mm when the central frequency is about 8 GHz and the wireless communication frequency range is about 7.5 GHz to 8.5 GHz.

Example 22 is the antenna system of any one of examples 1 to 21, wherein the plurality of antenna groups further includes a third antenna group including a third parasitic element and a third radiating element fed by a third antenna port, wherein the third antenna group is separated from the second antenna group by an elevation distance perpendicular to the distance along the ground plane, wherein the third antenna group mirrors the second antenna group along an axis of reflection that is parallel to the distance along the ground plane.

Example 23 is the antenna system of any one of examples 1 to 22, wherein a geometric height perpendicular to the ground plane of the first antenna group is less than about 5 mm.

Example 24 is the antenna system of example 23, wherein the geometric height is about 1.58 mm.

Example 25 is the antenna system of any one of examples 1 to 24, wherein the antenna system is configured to operate either or both of the first antenna group and the second antenna group as a sensing antenna for human radar detection.

Example 26 is the antenna system of any one of examples 1 to 25, wherein the antenna system is configured in a sensing antenna mode for human radar detection, wherein the sensing antenna mode includes operating one of the first antenna group and the second antenna group as a receiving antenna and operating the other of the first antenna group and the second antenna group as a transmitting antenna.

Example 27 is the antenna system of any one of examples 1 to 26, wherein the antenna system is configured in a ranging antenna mode for distance measurements, wherein the ranging antenna mode includes operating either the first antenna group or the second antenna group to obtain the distance measurements.

Example 28 is the antenna system of any one of examples 1 to 27, wherein the antenna system is configured in a ranging antenna mode for distance measurements, wherein the ranging antenna mode includes operating both the first antenna group and the second antenna group to obtain the distance measurements.

Example 29 is the antenna system of any one of examples 1 to 28, wherein the antenna system is configured in an angle-of-arrival antenna mode for angle measurements, where in the angle-of-arrival antenna mode includes operating both of the first antenna group and the second antenna group as receiving antennas.

Example 30 is the antenna system ofc any one of examples 1 to 29, wherein the first antenna group and the second antenna group are mirrored so as to remove surface waves and induce an electromagnetic balance within the antenna system.

Example 31 is the antenna system of any one of examples 1 to 30, wherein a phase difference between the first antenna group and the second antenna group is monotonic for different angles of arrival of received electromagnetic waves at the first antenna group and the second antenna group.

Example 32 is a computing system that includes a processor, an antenna system connected to the processor, and a chassis that encloses the processor and the antenna system. The antenna system includes a first antenna group of radiating elements and parasitic elements that mirrors a second antenna group of radiating elements and parasitic elements, a ground plane connected to each of the parasitic elements of the first and second group, and a pair of feed ports, each connected to a respective antenna group of the first and second antenna groups at one of the radiating elements of the respective antenna group.

Example 33 is the computing system of example 32, wherein the antenna system is attached to the chassis with an offset between the antenna system and the chassis.

Example 34 is the computing system of example 33, wherein the offset includes a keep-out zone between the chassis and the antenna system.

Example 35 is the computing system of example 34, wherein the keep-out zone includes an area less than about 40 mm by less than about 10 mm.

Example 36 is the computing system of example 35, wherein the keep-out zone is about 28.63 mm by about 3 mm.

While the invention has been particularly described above with reference to specific aspects in the disclosure above, it should be understood by those skilled in the art that various changes in form and detail to those aspects may be made without departing from the spirit and scope of the invention, as defined by the appended claims. The scope of the invention is thus indicated by the appended claims and all changes that are within the meaning and range of equivalency of the claims, are therefore intended to be embraced.

1. An antenna system comprising:
a plurality of antenna groups comprising a first antenna group and a second antenna group, wherein the first antenna group comprises a first parasitic element and a first radiating element fed by a first antenna port, wherein the second antenna group comprises a second parasitic element and a second radiating element fed by a second antenna port; and
a ground plane coupled to the first antenna group and the second antenna group, wherein the first antenna group is separated by a distance along the ground plane from the second antenna group, wherein the first antenna group mirrors the second antenna group.

2. The antenna system of claim 1, wherein the first antenna group mirrors the second antenna group with respect to an axis of reflection at a center of the distance, wherein the axis of reflection is perpendicular to the ground plane.

3. The antenna system of claim 1, wherein each of the first parasitic element and the second parasitic element is a meandered-shaped parasitic element.

4. The antenna system of claim 3, wherein the meandered-shaped parasitic element is L-shaped.

5. The antenna system of claim 3, wherein the meandered-shaped parasitic element includes:
a first portion that extends along the ground plane and is separated therefrom; and
a second portion that extends in a direction perpendicular to the ground plane and connects thereto, wherein an end of the first portion is connected to an end of the second portion.

6. The antenna system of claim 5, wherein the first portion is longer than the second portion.

7. The antenna system of claim 6, wherein the first parasitic element mirrors the second parasitic element with respect to an axis of reflection at a center of the distance, wherein the first portion extends along the ground plane away from the end of the second portion and towards the center.

8. The antenna system of claim 1, wherein the first antenna group comprises a first additional parasitic element and the second antenna group comprises a second additional parasitic element, wherein each of the first additional parasitic element and the second additional parasitic element is meandered-shaped.

9. The antenna system of claim 8, wherein the first parasitic element mirrors the first additional parasitic element across an axis of reflection of the first antenna group that is located at a geometric center of the first antenna group and is perpendicular to the ground plane.

10. The antenna system of claim 1, wherein each of a geometric extent of the first antenna group along the ground plane and a second geometric extent of the second antenna group along the ground plane comprises about half the distance.

11. The antenna system of claim 1, wherein the distance is about a half-wavelength (λ) at a central frequency of a wireless communication frequency range of the antenna system.

12. The antenna system of claim 1, wherein the plurality of antenna groups further comprises a third antenna group comprising a third parasitic element and a third radiating element fed by a third antenna port, wherein the third antenna group is separated from the second antenna group by an elevation distance perpendicular to the distance along the ground plane, wherein the third antenna group mirrors the second antenna group along an axis of reflection that is parallel to the distance along the ground plane.

13. The antenna system of claim 1, wherein the antenna system is configured in a sensing antenna mode for human radar detection, wherein the sensing antenna mode comprises operating one of the first antenna group and the second antenna group as a receiving antenna and operating the other of the first antenna group and the second antenna group as a transmitting antenna.

14. The antenna system of claim 1, wherein the antenna system is configured in a ranging antenna mode for distance measurements, wherein the ranging antenna mode comprises operating either or both the first antenna group and the second antenna group to obtain the distance measurements.

15. The antenna system of claim 1, wherein the antenna system is configured in an angle-of-arrival antenna mode for angle measurements, where in the angle-of-arrival antenna mode comprises operating both of the first antenna group and the second antenna group as receiving antennas.

16. The antenna system of claim 1, wherein a phase difference between the first antenna group and the second antenna group is monotonic for different angles of arrival of received electromagnetic waves at the first antenna group and the second antenna group.

17. A computing system comprising:
a processor;
an antenna system connected to the processor; and
a chassis that encloses the processor and the antenna system, wherein the antenna system comprises:
a first antenna group of radiating elements and parasitic elements that mirrors a second antenna group of radiating elements and parasitic elements;
a ground plane coupled to each of the parasitic elements of the first and second antenna group; and
a pair of feed ports, each connected to a respective antenna group of the first and second antenna groups at one of the radiating elements of the respective antenna group.

18. The computing system of claim 17, wherein the antenna system is attached to the chassis with an offset between the antenna system and the chassis.

19. The computing system of claim 18, wherein the offset comprises a keep-out zone between the chassis and the antenna system, wherein the keep-out zone comprises an area less than about 40 mm by less than about 10 mm.

20. The computing system of claim 19, wherein each of the parasitic elements of the first and second antenna groups is L-shaped.
